(19) United States
(12) Patent Application Publication
(10) Pub. No.: US 2025/0383765 A1
(43) Pub. Date: Dec. 18, 2025

(54) PORTABLE INFORMATION TERMINAL

(71) Applicant: Ubitone,INC., Tokyo (JP)

(72) Inventors: Eitaro YAMATSUTA, Tokyo (JP); Koji SATO, Tokyo (JP)

(21) Appl. No.: 18/875,786

(22) PCT Filed: Sep. 27, 2023
(86) PCT No.: PCT/JP2023/035124

§ 371 Date: Dec. 17, 2024

(30) Foreign Application Priority Data
Sep. 30, 2022 (JP) 2022-158368

(51) Int. Cl. G06F 3/04886; G06F 3/01; G06F 3/16; G08G 1/005; G08G 1/16; G09B 21/00

(52) U.S. Cl. CPC G06F 3/04886; G06F 3/016; G06F 3/167; G08G 1/005; G08G 1/166; G09B 21/004; G06F 2203/04803

(57) ABSTRACT

Provided is a mobile information terminal with a display screen superior in responsiveness that causes few tapping errors for a visually impaired person, and that is capable of operating together with an external device. In the mobile information terminal, input/output sections are formed by dividing an entire display screen into 8 sections with partitions with orthogonality, and each of the input/output sections is positioned within the entire display screen relative it. Representatively, in the mobile information terminal, the input/output sections formed by dividing an entire display screen into 8 sections by partitions with orthogonality has a total number of 8 sections being 1 finger number for each hand having an operation function added to 1 to 6 finger braille numbers assigned to three fingers of each hand of a visually and hearing impaired person, and each of the input/output sections is positioned within the entire display screen relative it.

### TECHNICAL FIELD

The present invention relates to a mobile information terminal having a display screen superior in responsiveness that causes few tapping errors for a visually impaired person, and that is capable of operating together with an external device.

### BACKGROUND ART

There are techniques such as finger braille that receives information through an interpreter by likening the index finger, the middle finger, and the ring finger of both hands to braille of 6 points, as one communication means of a visually and hearing impaired person, in particular, a blind/deaf person. Moreover, in the case where a blind/deaf person can touch braille, an electronic braille keyboard also exists that can send and receive information by inputting/outputting braille of 6 points. In addition to this, in recent years, finger braille devices of a finger-worn type have also been provided (Patent Literature 1 and Patent Literature 2) in which a blind/deaf person can send and receive information even without the intervention of an interpreter.

However, while the finger braille device of Patent Literature 1 can receive finger braille information from another person, an intention cannot be conveyed to another person. Moreover, in the finger braille device of Patent Literature 2, while there is an advantage for the point of enabling finger braille information to be conveyed bidirectionally, there is an impediment at the time when using important finger pads as a tactile function of a blind/deaf person, other tactile functions by the finger pads cannot be sufficiently used at the same time as when wearing the finger braille device, and it is necessary to remove the finger braille device from the hands each time when another tactile function is to be used. Therefore, a point of improvement such as not being able to constantly wear on the hands is included.

By taking into consideration these points, the inventors have developed a finger braille device of a finger-mounted type (hereinafter, a “finger-mounted finger braille device”), in which the finger pads are completely released, that enables bidirectional communication superior for constant portability. However, while it can be said that a finger-mounted finger braille device superior for constant portability is provided, in the case where a device that receives sent finger braille information and transmits finger braille information to a finger-mounted finger braille device is a dedicated device not having portability, it will not be possible to constantly utilize the finger-mounted finger braille device in daily activities.

Moreover, in recent years, generally healthy people are constantly carrying a smartphone, and there is a current situation in which at least a visually and hearing impaired person constantly carries a smartphone by activating a voice reading function, and this has become a core part of receiving and sending of information in daily activities. Therefore, in order for a finger-mounted finger braille device to be constantly carried in daily activities, it is considered that the potential needs are significant for applications in a smartphone to be developed that operate together with external devices other than a finger-mounted finger braille device. Moreover, from the practical viewpoint of the SDGs pledge of “Leave No One behind”, there is a great significance of “Leave No Blind/Deaf Person Behind” from smartphone utilization society.

On the other hand, by simply developing apps for a smartphone that enable bidirectional information conveyance with a finger-mounted finger braille device, it cannot be said to be advantageous for a blind/deaf person having both visual and hearing impairments, for whom utilization of a smartphone is difficult, and the inventors consider that it is difficult to build a society in which regular use of standalone finger-mounted finger braille devices described above and smartphones is progressing.

### CITATION LIST

### Patent Literature

Patent Literature 1: Japanese Patent Laid-Open No. 2002-123169
Patent Literature 2: Japanese Patent Laid-Open No. 2020-046666

### SUMMARY OF INVENTION

### Technical Problem

The present invention has been created by taking into consideration the above problems, and has an objective to provide a mobile information terminal having a display screen superior in responsiveness that causes few tapping errors for a visually and hearing impaired person such as a blind/deaf person or the like (hereinafter, also called a “blind/deaf person or the like”) as a standalone mobile information terminal (hereinafter, also called a “smartphone”). Moreover, at the same time, the present invention has an objective to provide a mobile information terminal that can acquire advantageous information and perform management of daily activities of a visually and hearing impaired person while operating together with an external device such as a finger-mounted finger braille device.

### Solution to Problem

The present invention provides a mobile information terminal that has input/output sections formed by dividing an entire display screen into 8 sections by partitions with orthogonality, and has each of the input/output sections positioned within the entire display screen relative it.

On a display screen with a touch input system in a normal mobile information terminal (hereinafter, also called a “smartphone”), input/output sections (hereinafter, also called “blocks”) of various sizes, in which a user performs a page transition or character input, and outputs content of information of a transition destination, are displayed at various locations. The user sets a desired position and size by zooming or scrolling the input/output sections on the display screen, acquires information by tapping an input/output section as an input, and performs a transition to a screen of a lower hierarchy level.

However, in the case of a visually and hearing impaired person such as a blind/deaf person or the like, even if the position of an outer frame or a display screen frame of the smartphone can be recognized by touch, it is difficult to recognize the position of input/output sections for which the position and size within the display screen are not fixed.

The inventors, as a result of interviewing and monitoring a large number of visually and hearing impaired people, have understood that this problem of position recognition of an input screen is a significant barrier of smartphone activity for a visually and hearing impaired person, in particular, a blind/deaf person. Note that, there is blindness, low vision, and a limited visual field in visual impairments, there is a wide variety of “difficult to see” such as a difficulty occurring in an identification of shapes, a response to brightness or darkness, a reading speed of characters, or an identification of colors with a low contrast difference, there may be cases of having an impairment for only vision, and there may be cases of having an impairment of not only vision, but also of hearing. Accordingly, in the present specification, in the case of naming a “visually impaired person”, a “visually and hearing impaired person”, and a “blind/deaf person”, there is a meaning of people having impairments of vision in a broad sense.

Therefore, in the present invention, input/output sections of a smartphone are adopted in which input/output sections of a fixed position, size, and number are set on a display screen, even if limited to some extent, rather than increasing the number of input/output sections that can be selected or making input/output sections larger to be easier to see. Moreover, as a result of interviews and monitoring described above, and experiments of position recognition and input accuracy of visually and hearing impaired people, which are described below, it is understood that it is important for a visually and hearing impaired person to be able to recognize that input/output sections have a position easily understood with respect to the display screen that is fixed, and the degree of position recognition and the input accuracy of input/output sections is high for input/output sections “divided” by partitions having “orthogonality” from an “entire” display screen, and input/output sections “fixed (positioned)” on a screen in this state. Based on these facts, a smartphone for a visually and hearing impaired person is provided in the present invention.

By providing such a smartphone for a visually and hearing impaired person of the present invention, a visually and hearing impaired person can constantly tap an input/output section of an assumed position with respect to the entire display screen, and can use a smartphone, and attempt communication with a general smartphone user, without stress, even if not using a dedicated braille device.

In addition to this, the number of braille for a visually and hearing impaired person is 6, and a display screen formed by input/output sections of a number that adds input/output sections for operations to this number (for example, input/output sections having so-called functional functions L and R, which are described below) will be easy to image for a visually and hearing impaired person. In addition, it is preferable for the input/output sections of a display screen to have an even number, which becomes a basis for input/output sections to be formed by being divided by “partitions” having “orthogonality”, and it is also necessary to take into consideration a visually and hearing impaired person missing one part of the ten fingers of both hands. As a result, in the present invention, input/output sections are adopted by dividing the display screen into “8 sections”.

In the present invention, by collecting together the above matters, a configuration is provided that “fixes (positions)” input/output sections on a display screen by “dividing” the “entire” display screen of a smartphone into “8 sections” by “partitions” having “orthogonality”.

Moreover, in the mobile information terminal of the present invention, it is preferable that:
the input/output sections are formed by dividing an entire display screen into 8 sections by partitions with orthogonality each input/output section consists of a total number of 8 sections, which include finger braille numbers assigned to three fingers of each hand of a visually and hearing impaired person, along with the two operation functions assigned to the other one finger of each hand, and each of the input/output sections is positioned within the entire display screen relative it.

As described above, there is finger braille, which expresses images of general braille by stimulation to the fingers, as a familiar conventional communication technique that is used daily by a visually and hearing impaired person such as a blind/deaf person or the like, and in a preferred configuration example of the mobile information terminal (smartphone) of the present invention, the mobile information terminal (smartphone) is set with a display screen having an operability close to that of finger braille operations, and in addition, can follow the operability of an existing electronic braille keyboard for finger braille or the finger-mounted finger braille device described above.

Specifically, for finger braille assigned to 6 fingers of both hands (the index finger to the ring finger (other fingers in the case where missing a finger)) for 6 braille of 2 columns and 3 rows, on a menu screen, or a representative transition screen thereafter, of the preferable mobile information terminal, the entire display screen is divided into 8 sections by totaling a number of 6 of the 6 fingers assigned from the index finger to the ring finger of both hands by finger braille, and a number of 2 of the thumbs of both hands corresponding to function operations used by an electronic braille keyboard or a finger-mounted finger braille device, and each of these sections is fixed on the display screen as an input/output section.

In this way, a visually and hearing impaired person can constantly tap an input/output section at an assumed position with respect to the entire display screen, while utilizing a familiar operation image of finger braille without change.

Moreover, in the mobile information terminal of the present invention, it is preferable that:
each of the input/output sections is formed by dividing the entire display screen into 8 sections having a substantially same area and shape of 2 columns and 4 rows by the partitions with orthogonality, and the display screen is configured of 3 rows of a left column assumingly assigned to 3 fingers of the left hand of the visually and hearing impaired person, 3 rows of a right column assumingly assigned to 3 fingers of the right hand of the visually and hearing impaired person, and 2 columns of a bottommost row assigned to both the left and right thumbs of the visually and hearing impaired person.

Here, 8 sections in which the entire display screen is divided into 2 columns and 4 rows are exemplified as a representative input/output section, such as a menu screen. The number of braille is standardized by the protrusions assigned to 1 to 6 of 2 columns and 3 rows, and in the input/output sections of a preferable mobile information terminal, the entire display screen is divided into 2 columns and 4 rows so as to be easily imaged by a visually and hearing impaired person by corresponding to numbers 1 to 6 of braille, and an input/output section group, which is used by assigning numbers 1 to 3 of braille by the 3 fingers of the left hand (for example, the index finger to the ring finger) to the top 3 rows of the left column and numbers 4 to 6 of braille by the 3 fingers of the right hand (for example, the index finger to the ring finger) to the top 3 rows of the right column, and 1 finger (for example, the thumb) of each of the left and right hands to the bottommost 2 rows, is fixed on the display screen. The term ‘the entire display screen’ refers to a fixed area that a visually impaired person used the present mobile information terminal recognizes as the entire display screen. Therefore, ‘the entire display screen’ may refer, for example, to the entire display screen displaying an image composed of pixels, or it may refer to the image

This is because it is understood that, in the provision of such a configuration example, it is preferable that the display screen of the smartphone is also divided into 2 columns and 3 rows corresponding to 1 to 3 of the left column and 4 to 6 of the right column of braille, from the viewpoint of position recognition and a pressing input accuracy, and since the thumbs of both hands are each set as a finger for an input of a so-called functional function (transition operation of the screen or the like), even in an existing electronic braille keyboard or a finger braille device of a finger-mounted type (hereinafter, also called a “finger-mounted finger braille device”), it is preferable that these inputs are set to corresponding input/output sections in the smartphone display screen.

Therefore, in the present invention, the display screen is fixedly set as a main screen (main screen) of input/output sections divided into 8 sections of 2 columns and 4 rows by partitions with orthogonality.

Moreover, according to the mobile information terminal of the present invention, the input/output sections may be formed by dividing the display screen into sections with a substantially same shape of 1 column and 6 rows from the top and dividing the bottommost row into 2 columns, by the partitions with orthogonality.

While an example has been described above that forms the input/output sections by orthogonally dividing into 2 columns and 4 rows as a main screen (main screen) of the display screen, 1 column and 6 rows, with the bottommost row having 2 columns, which is mainly divided in a horizontal direction, is exemplified as another aspect (sub-screen), in particular, a screen after transition. In the example of this aspect, each input/output section is divided into 8 input/output sections in 1 column of a same width and fixed, and are set to fixed input/output sections configured of the top 6 rows assumed as numbers 1 to 6 of braille by the 6 fingers of the left and right hands (for example, the index finger to the ring finger of the left hand and the index finger to the ring finger of the right hand) and the bottommost 2 rows having a functional function assigned to 1 finger (for example, the thumb) of each of the left and right hands. In particular, in the simple format of the main screen for tapping each of the 8 input/output sections of 2 columns and 4 rows described above, on a display screen for character input or the like that seems as if it cannot respond, rows of 1 to 6, which combine input/output sections that are used for an input for each row and so-called blank input/output sections that are not used for an input for each row, can be set, an input can be performed while selecting a position of an image of finger braille of 1 to 6 without change, by setting the bottommost 2 columns as rows having a functional function, and the functional functions of the bottommost row can be selected by the left and right thumbs. Therefore, a display screen matched to various usage aspects, which can create a complementary display screen of a main screen (main screen) divided into 2 columns and 4 rows, can be provided.

Moreover, in the mobile information terminal of the present invention,
when the prescribed input/output section inside the display screen is selected and input, the prescribed input/output section may transition to another display screen having a preset fixed input/output section divided into 8 sections by partitions with orthogonality.

In the case where transitioning to a page by selecting and inputting an arbitrary input/output section inside the display screen of the smartphone, the input/output sections of the page of the transition destination are also fixed on the entire display screen by dividing the display screen similar to that prior to transition. By having the transition destination also divided and fixed with respect to the display screen, a visually and hearing impaired person can perform operations similar to not only the main screen (main page), but also other pages. There are roughly two aspects for a transition of a display screen: a hierarchy level transition that transitions to a page of a lower hierarchy level by tapping a desired input/output section 1 to 6 of the page prior to an arbitrary transition (or an upper hierarchy level in the case of returning by tapping the input/output sections L and R having a so-called functional function), and a scroll transition that moves the cursor in the order of the input/output sections of the page prior to an arbitrary transition, and transitions from the bottommost row of the page (excluding the input/output sections having a functional function) to an input/output section of the uppermost row of the next display screen. Both aspects have the page of a transition destination set to a page having divided and fixed input/output sections.

For example, in a hierarchy level transition, when one of the blocks of 1 to 6 assigned to the numbers of braille of the main page is double-tapped such as shown in FIGS. 4A-4D, which is described below, a page that is a destination of this block is also set to 1 to 6 assigned to the numbers of braille and blocks L and R having a functional function of the bottommost row. Moreover, for example, in a scroll transition, the necessary blocks are 1 to 12 such as shown in FIGS. 9A-9C, which is described below, and in the case where a page prior to transition is set with 1 column and 7 rows, which has 1 to 6 blocks assigned to the numbers of braille and blocks L and R of the bottommost row, the cursor is moved in the order of blocks 1 to 6, and when the cursor reaches block 6 and an operation is performed to further move the cursor, the cursor transitions to a page of the same 1 column and 7 rows, is matched with block 1 (corresponding to 7) of the uppermost row of 7 to 12 and functions L and R of a page of a transition destination, and there is a feeling of scrolling for each screen.

Moreover, in the mobile information terminal of the present invention, there may be cases in which
the input/output section is displayed as one section having a same transition destination as adjacent one or more input/output sections and integrated with the one or more input/output sections, or
the input/output section does not have a transition destination and is in a display state incapable of input and output.

In the display screen of the smartphone, while there is a block group (input/output section group) divided into 8 sections by partitions with orthogonality, in terms of internal processing, various types of display screens can be created, which can set one block capable of input by collecting a plurality of blocks, and can set blocks unable to perform input, such as only having 5 selections, for example, in terms of display.

Moreover, it is preferable for the mobile information terminal to include:
a transmission/reception unit that performs information transmission and reception wirelessly with an external device,
an input unit that inputs operation information to the input/output sections of the display screen of the mobile information terminal and input information to the external device based on the operation information, and transmits the input information to the external device to the transmission/reception unit, and
a display unit that outputs the operation information to the input/output sections of the display screen of the mobile information terminal and the output information from the external device received by the transmission/reception unit, and displays the operation information and the output information on a display screen of the mobile information terminal.

In the smartphone, input information performed by an input operation such as double-tapping a block inside the display screen can be input by an input unit, and a character input or a transition screen inside the smartphone can be displayed on a display unit. Moreover, in the case where an external device is an output device of the smartphone, input information to the display screen inside the smartphone can be wirelessly transmitted as input information to the external device, and in the case where an external device is an input device of the smartphone, input information by wireless communication from the external device can be displayed on the display screen inside the smartphone.

Moreover, in the mobile information terminal of the present invention,
it is preferable for the external device to be a finger-mounted finger braille device attached to each finger of the left and right hands and capable of bidirectional wireless communication that can transmit to the mobile information terminal finger braille information from each finger or receive the finger braille information from the mobile information terminal, and
it is preferable for the finger-mounted finger braille device to include:
an input/output unit, provided on a back side of each of the fingers, and including an operation detection unit that detects a finger braille operation of each of the fingers and a vibration unit that transmits finger braille to each of the fingers,
a main body unit that receives an operation signal corresponding to the finger braille operation of each of the fingers detected by the operation detection unit and specifies character information based on the operation signal, receives character information from the mobile information terminal and specifies a vibration operation to each of the fingers based on the character information, and transmits the specified vibration operation to the input/output unit, and
a transmission/reception unit that wirelessly transmits the character information specified by the main body unit to the mobile information terminal, receives the character information from the mobile information terminal, and transmits the received character information to the main body unit.

A finger-mounted finger braille device is exemplified as a representative example of an external device that operates together with the mobile information terminal. This finger-mounted finger braille device can function as an input tool of a block inside the display screen of the smartphone, or can function as an output tool that conveys an operation at a block inside the display screen of the smartphone to a visually and hearing impaired person by vibrations of finger braille. Accordingly, this finger-mounted finger braille device can have a role as an indispensable input/output device for a visually and hearing impaired person using the smartphone, which is described below, and has an advantage for the point of being able to be used by operating together with the smartphone in examples of an activity application of the smartphone, which are described below.

Note that, “character information” stated here includes not only character information for finger braille, but also information based on so-called function operations (for example, L and R, which are described below).

Moreover, in the mobile information terminal of the present invention,
character information recognized by a voice recognition function built into the mobile information terminal may be displayed on the input/output sections divided by the partitions with orthogonality inside the display screen, and the character information may be wirelessly transmitted to the finger-mounted finger braille device, and
the character information input to the input/output sections divided by the partitions with orthogonality inside the display screen may be recognized by a voice reading function built into the mobile information terminal, and the recognized character information may be output by a voice.

According to the mobile information terminal, a visually and hearing impaired person equipped with the above-described finger-mounted finger braille device can have a dialogue with a caregiver or the like on the smartphone placed in front of them. Specifically, a visually and hearing impaired person can perform a smooth conversation using the smartphone, even without a person in front of them (caregiver or the like) being a braille translator, by having the caregiver or the like perform character input and display on a block inside the display screen of the smartphone by a voice recognition function when the caregiver or the like is performing a dialogue, and having the visually and hearing impaired person perform character input and display on a block inside the display screen of the smartphone by using a finger-mounted finger braille device.

Moreover, as an example, it is preferable for the external device to be a health management measurement device capable of wirelessly transmitting measurement information, in which
in the mobile information terminal, the measurement information is received from the measurement device, the received measurement information is displayed along with a measurement date/time on the input/output sections divided by the partitions with orthogonality inside one display screen of the mobile information terminal, the displayed measurement information is stored in the mobile information terminal or stored in a server capable of communicating with the mobile information terminal, and each measurement information stored in each input/output section of another display screen transitioned from the one display screen displayed with the measurement date/time is displayed along with a date/time, and a history list display is formed.

A visually and hearing impaired person has a problem of knowing a measurement value of his or her own temperature, body weight, blood pressure or the like. On the other hand, in recent years, thermometers, weight scales, and blood pressure machines capable of near-field communication such as Bluetooth (R) have become general-purpose devices, and in the mobile information terminal, measurement information codes can be used for daily health management. Specifically, measurement data of a thermometer or the like can be received and displayed on a block inside the above-described display screen, this data can be recorded as a history, and this data can be called out as a list. Note that, a “measurement date/time” stated here includes the case where displaying only a measurement date, and the case where displaying a measurement date and time. This is because there may be cases where a body weight or the like is measured one time in one day, and cases where temperature, blood pressure or the like is measured several time in one day. Moreover, other than this, the case where displayed as “date/time” in the specification of the present invention means a “day and/or time (may include minutes and seconds)”.

Moreover, as another example, the external device is a recording tag with a built-in RFID capable of being attached to an arbitrary product, the recording tag recording product information in a rewritable manner, in which
in the mobile information terminal,
when the product information is input at a prescribed input/output section of the mobile information terminal, an RFID reader/writer built into the mobile information terminal is started, causes the product information to be recorded and updated in the recording tag by transmitting the product information, the RFID reader/writer receives the product information recorded and updated by the recording tag, and the received product information is recorded and updated by the mobile information terminal or by a server that performs bidirectional communication with the mobile information terminal, and
when reading instruction information of the recording tag is input at another prescribed input/output section of the mobile information terminal, the RFID reader/writer is activated, the RFID reader/writer receives the product information recorded to the recording tag by transmitting the reading instruction information, and the received product information is displayed on the prescribed input/output section of the mobile information terminal.

A visually and hearing impaired person has a problem in which an expiration date or the like of purchased food and drink or home-made food and drink inside a refrigerator cannot be determined. In order to solve this problem, in an example of the mobile information terminal, a recording tag with a built-in RFID can be used that is capable of storing and updating product information such as an expiration date of food and drink, an expiration date of food and drink attached to the recording tag can be registered by an RFID reader/writer built into the smartphone, and an expiration date or the like at the present time can be determined by appropriately performing reading at the time of eating or drinking. Such a product management using the smartphone can be performed.

Moreover, another example of an external device is a doorbell unit and finger-mounted finger braille device that transmits and receives a doorbell and a voice, in which
in the mobile information terminal,
doorbell voice information is wirelessly received from the doorbell unit, the received doorbell voice information is displayed as character information along with a received date/time on a prescribed input/output section inside the display screen of the mobile information terminal, and the character information is transmitted to the finger-mounted finger braille device, and
the character information is wirelessly received from the finger-mounted finger braille device, the received character information is displayed as character information on the prescribed input/output section of the mobile information terminal, and the character information is wirelessly transmitted as doorbell voice information output by the doorbell unit.

There is a problem of not realizing that a friend or delivery worker has rung a doorbell, as another representative worry in everyday activity of a visually and hearing impaired person, and in the smartphone of the present invention, there is an advantage for the point of not only receiving a notification of a doorbell, but also enabling dialogue, by having a doorbell, the smartphone, and a finger-mounted finger braille device operating together.

Moreover, another example of an external device is a visually impaired person foot-mounted tool and finger-mounted finger braille device that receives guidance information from an IC tag installed in a pedestrian path, in which
in the mobile information terminal,
the visually impaired person foot-mounted tool wirelessly transmits a guidance information signal by reading the guidance information of the IC tag in the pedestrian path by a built-in RFID reader, and
the guidance information signal is wirelessly transmitted to the finger-mounted finger braille device via the mobile information terminal wirelessly receiving the guidance information from the visually impaired person foot-mounted tool.

While conventional technology that assists walking of a visually impaired person exists, it is not practical (described in detail below). However, in the present invention, walking should be safely and effectively assisted from the feet, in addition to a white cane, by wearing a tool on a lower limb, such as on the ankle of one leg, IC tags are installed in a plurality of braille blocks along a pedestrian path, and guidance information signals such as a warning are guided by vibrations from a vibration unit of a finger-mounted finger braille device via the smartphone, by reading these IC tags by an RFID reader built into a visually impaired person foot-mounted tool worn on the foot with high communication accuracy near the braille blocks. Moreover, the visually impaired person foot-mounted tool of the present invention is simply worn on a lower limb, and has an advantage for the point of having a high level of general usage and propagation for the points of being freely removable and not requiring dedicated shoes to be worn.

In addition, as another external device, a mobile braille display and finger braille input device may be provided that displays braille by wirelessly receiving character information from the mobile information terminal. This braille display and finger braille input device includes:
a transmission/reception unit that wirelessly receives the character information from the mobile information terminal and wirelessly transmits the character information input by the braille display and finger braille input device, a braille display unit arranged with a plurality of braille formed by causing a pin to protrude and retract, a vibration unit that specifies a vibration of the pin for each braille based on the character information received by the transmission/reception unit from the mobile information terminal or the character information input by the braille display and finger braille input device, and causes the pin to protrude and retract, a finger braille input key having 6 keys corresponding to 3 fingers of each hand, and a finger braille input unit that transmits the character information input by the finger braille input key to the transmission/reception unit or the vibration unit.

While the present inventors have assumed, as a representative external device, the above-described finger-mounted finger braille device (refer to FIGS. 2B and 2C, which are described below) as an external device that can perform transmission and reception with a mobile information terminal, the present inventors also considered the case, from hearing of a visually and hearing impaired person, where a reading speed is faster for braille than finger braille, and a visually and hearing impaired person desiring repeated learning of active reading comprehension and text such as “news” or “braille library” is not satisfied by simply carrying, as an external device, the finger-mounted finger braille device as a reading device (reception device).

In response to this, there are electronic braille devices, which are provided with a conventional input keyboard, and a display unit that displays braille by having pins, which display dots raised from holes pierced in a flat surface on a lower part (refer to FIG. 2A, which is described below). However, while a conventional electronic braille device is superior for the point of enabling reading by braille, it is large and heavy, the portability is remarkably poor, and it cannot be adopted for the point of operating together with the mobile information terminal of the present invention while being carried as an external device. A portable braille display and finger braille input device is provided as an external device, which is used for an improvement of a reading speed instead of a finger-mounted finger braille device operating together with the mobile information terminal of the present invention or by so-called simultaneous holding, by extracting and installing a reading function by a braille display (character output function) and a minimum character input function necessary for finger braille, in an electronic braille device provided as an example of an external device of the mobile information terminal.

Note that, in the above-described braille display and finger braille input device, it is preferable for character information wirelessly received from the mobile information terminal of the present invention, in the transmission/reception unit, to be braille character information in which general character information input by the mobile information terminal has been converted into braille information within the mobile information terminal, and it is preferable for character information wirelessly transmitted from the finger braille input unit of the braille display and finger braille input device via the transmission unit to be finger braille information, and for this finger braille information to be converted into general character information within the mobile information terminal receiving this finger braille information. While consideration can be made to convert finger braille information input inside the braille display and finger braille input device, to convert received general character information into braille information, or to perform conversion by a cloud server wirelessly communicating with the mobile information terminal, it is preferable to perform a conversion process inside the mobile information terminal, which takes into consideration the case where performing conversion at an external communication destination other than a cloud server or the like, or the case where the braille display and finger braille input device is used in a location incomplete or unstable as a communication environment. The cost and space for a built-in conversion processing unit is important when performing conversion within the braille display and finger braille input device, and there is the possibility of deviating from the basic thinking of a small-sized braille display and finger braille input device having a reading function by a braille display and a minimum character input function necessary for finger braille. A conversion process is executed by the mobile information terminal of the present invention that is carried a close distance from the braille display and finger braille input device.

### BRIEF DESCRIPTION OF DRAWINGS

1A shows a schematic diagram of the rules of braille, and FIG. 1B shows a schematic diagram of the rules of finger braille associated with the braille of FIG. 1A, as figures for describing braille and finger braille.

FIG. 2A shows a photographed image of a braille keyboard as an external device, FIG. 2B shows a photographed image of a finger-mounted device as an external device, and FIG. 2C shows a photographed image of a state in which the finger-mounted device of FIG. 2B is worn on the right hand.

FIGS. 3A-3H show an example that sets input/output sections by dividing a display screen of the mobile information terminal of the present invention into 2 columns and 4 rows.

FIGS. 4A-4D show a specific example of a display screen having input/output sections divided into 2 columns and 4 rows.

FIGS. 5A-5E show a display screen to which a hierarchy level transition has been performed from FIG. 4A, and the usage aspect thereof.

FIG. 6A-6E show simulated divided display screens and reaction areas of each block for 5 types of smartphones that were actually used in experiments. FIG. 6F indicates a value of each block.

FIGS. 7A-7B show graph diagrams showing a required time of each tapping point and a total score of tapping points at this time by each simulated divided display screen in test subject A.

FIG. 8 shows a graph diagram showing a required time of each tapping point and a total score of tapping points at this time by each simulated divided display screen in test subject B.

FIGS. 9A-9C show an example that sets input/output sections by dividing a display screen of the mobile information terminal into 8 sections of 1 column and 7 rows (with the bottommost row having 2 columns).

FIGS. 10A-10E are conceptual diagrams showing examples in which the mobile information terminal of the present invention and various types of external devices are used by operating together.

FIGS. 11A-11E show an example of a display screen for an application that manages information from a health measurement device by the smartphone, as a usage example of the mobile information terminal of the present invention.

FIGS. 12A-12D shows an example of a display screen for an information management application by a recording tag, as a usage example of the mobile information terminal of the present invention.

FIG. 13 is an image diagram that manages calling of a doorbell/dialogue, as a usage example of the mobile information terminal of the present invention.

FIGS. 14A-14C show an example of a display screen of the mobile information terminal of the present invention at the time when performing calling of a doorbell/dialogue of the image diagram of FIG. 13.

FIG. 15 is an image diagram showing pedestrian navigation, as a usage example of the mobile information terminal of the present invention.

FIGS. 16A-16D are figures showing a visually impaired person foot-mounted tool and a finger-mounted finger braille device operating together with this hearing impaired person foot-mounted tool as an example of an external device used in pedestrian navigation, as a usage example of the mobile information terminal of the present invention.

FIGS. 17A-17B show a perspective view and a plan view of a visually impaired person foot-mounted tool as an example of an external device that operates together with the mobile information terminal of the present invention.

FIGS. 18A-18B show a braille display and finger braille input device as an example of an external device that operates together with the mobile information terminal of the present invention.

### DESCRIPTION OF EMBODIMENTS

First, as a premise for describing the embodiments of a mobile information terminal of the present invention, an outline of a braille keyboard and a finger-mounted finger braille device, with braille and finger braille, as an external device that communicates with the mobile information terminal of the present invention, will be described. Note that, the details of examples of various types of external devices such as a finger-mounted finger braille device and others will be described below.

In FIGS. 1A-1B, FIG. 1A shows a schematic diagram of the rules of braille, and FIG. 1B shows a schematic diagram of rules for finger braille correlated with the braille of FIG. 1A, as figures for describing braille and finger braille. In braille generally used by visually impaired people and visually and hearing impaired people, such as shown by circular numbers 1 to 6 (in the present specification, also called “braille numbers 1 to 6”) on the left side of FIG. 1A, one single character of braille is made up of 6 dots. In this way, characters of 2\hat{ }6=64 can be expressed.

Moreover, finger braille generally has 3 fingers of each of the left and right hands assigned to the braille numbers 1 to 6, and as shown in FIG. 1B, the individual braille numbers (dot numbers) of FIG. 1A are assigned as 1, 2, and 3 from the top left downward (for example, the ring ringer to the index finger of the left hand) and as 4, 5, and 6 from the top right downward (for example, the ring ringer to the index finger of the right hand). A braille translator (hereinafter, collectively called a “caregiver” as people who communicate with a blind/deaf person or the like) conveys a language to be conveyed by finger braille, by touching a finger of the blind/deaf person or the like to a braille number translating the language. For example, in the example on the left side of FIG. 1A, in the case where braille corresponding to a translated language become the 1, 3, and 6 dots, the English letter U is expressed, and the braille translator conveys the English letter U by touching the index finger and the ring finger of the left hand and the ring finger of the right hand to which 1, 3, and 6 are assigned.

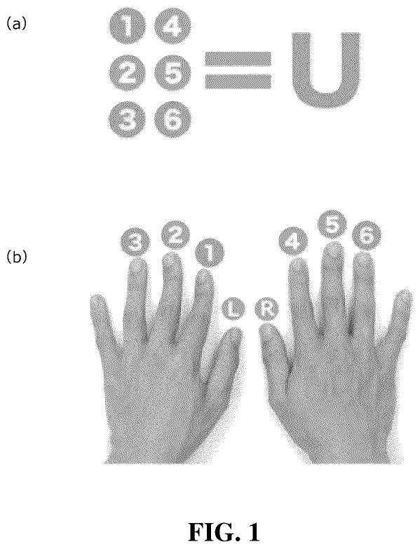

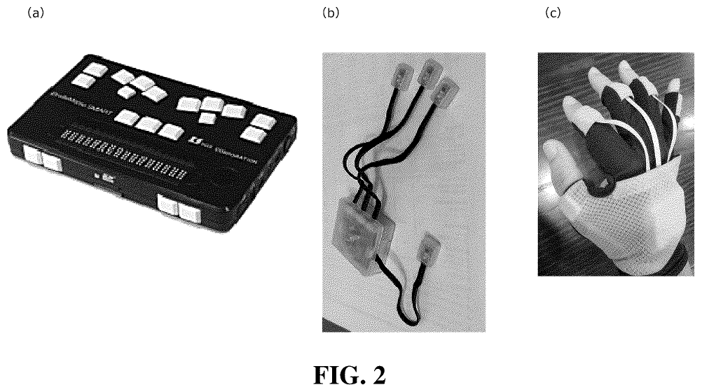

Moreover, in FIGS. 2A-2C, FIG. 2A shows a photographed image of a braille keyboard as an external device, FIG. 2B shows a photographed image of a finger-mounted device as an external device, and FIG. 2C shows a photographed image of a state in which the finger-mounted device of FIG. 2B is worn on the right hand. The braille keyboard shown in FIG. 2A is a general-purpose keyboard that can perform character conversion, by assigning the braille numbers 1 to 6 shown in FIG. 1A as the numbers of the fingers of both hands such as in FIG. 1B, and inputting a combination of assigned numbers of each of the fingers. This braille keyboard has a plurality of function keys, functions as a word processor/PC, and representatively uses the thumb of each hand (refer to the circular L and R of FIG. 1B) for an input as fingers other than the fingers assigned for braille.

In addition, the finger-mounted device shown in FIGS. 2B and 2C, similar to the rules of the braille keyboard described above, performs an input, by assigning braille numbers 1 to 6 as numbers for the fingers of each hand and functions keys (refer to FIG. 1B), and detecting tapping operations of the fingers (simultaneous tapping of the braille numbers 1 to 6 and the function keys L and R is also possible). This finger-mounted device can perform bidirectional communication, and not only can an input operation (signal transmission) be performed by a same image as that of a braille keyboard, but it is also possible to convey received signals of 1 to 6 and function keys L and R assigned by the smartphone or the like to each of the fingers. The details will be described below.

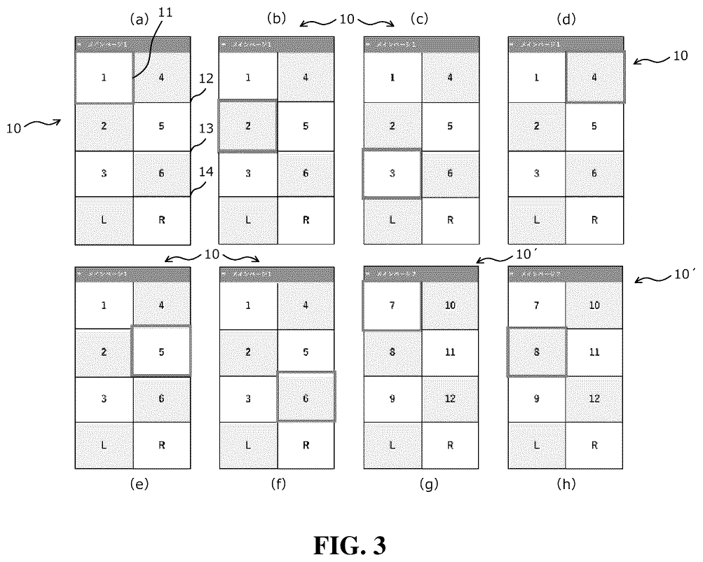

Next, as an embodiment of a mobile information terminal of the present invention, an explanation will be performed by exemplifying a display screen and input/output sections while referring to FIGS. 3A to 6 and 9A-9C. Note that, the embodiments shown in the specification and drawings are examples of the present invention, and other various improvement examples and modifications present from the thoughts and teachings of the present claims would be obvious for a person skilled in the art.

<<Example of a Main Screen with 2 Columns and 4 Rows>>

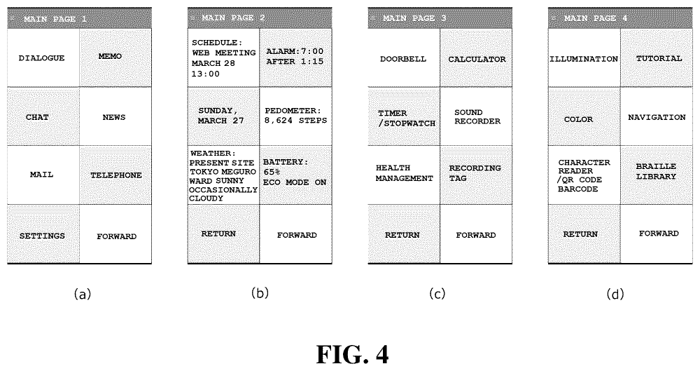

FIGS. 3A-3H show an example that sets input/output sections (hereinafter, also simply called “blocks”) by dividing a display screen of the mobile information terminal into 2 columns and 4 rows, and FIGS. 4A-4D show a specific example of a display screen having input/output sections divided into 2 columns and 4 rows. FIGS. 3A to 3F each show a display screen 10 in which 8 blocks 1 to 6 and L and R of 2 columns and 4 rows are set by dividing the entire display screen 10 of the smartphone, and FIGS. 3G and 3H each show a display screen 10′ in which blocks 7 to 12 and L and R of 2 columns and 4 rows, which are so-called scrolled from FIGS. 3A to 3F, are set. Each of the blocks is formed by having the entire display screen 10 divided into 8 blocks by a vertical partition 11 and horizontal partitions 12 to 14 with orthogonality, zooming and scrolling inside the display screen 10 such as in a general smartphone cannot be performed, the display screen 10 is fixed as one screen, and the blocks 7 to 12 and L and R are displayed by transitioning from the display screen 10 to the display screen 10′ without breaking the sequence of blocks as one screen.

An application for a visually and hearing impaired person such as a blind/deaf person or the like is installed in the mobile information terminal, and the present invention can be used by activating this application (hereinafter, also simply called an “app”). Firstly, an input to the app accepts both an input by a touch to the display screen 10 and an input from an external device.

A direct input for tapping and double-tapping the display screen 10 will be described. At the time when the app is started and a page transitions to the display screen 10, a cursor is matched to block 1 such as shown by the bold frame of FIG. 3A, page information (for example, refer to four examples of a “main page” of FIGS. 4A-4D) transitioned by a voice reading function equipped as standard in a smartphone is read out, and thereafter the block 1 matched with the cursor is read out. For example, in the case of the main page example of FIG. 4A, the cursor is matched with the “dialogue” of block 1 at the time of transition, “Main Page 1” “Dialogue” is read out, the input of the block 1 is confirmed by double-tapping, and a transition to the page of “dialogue” is performed.

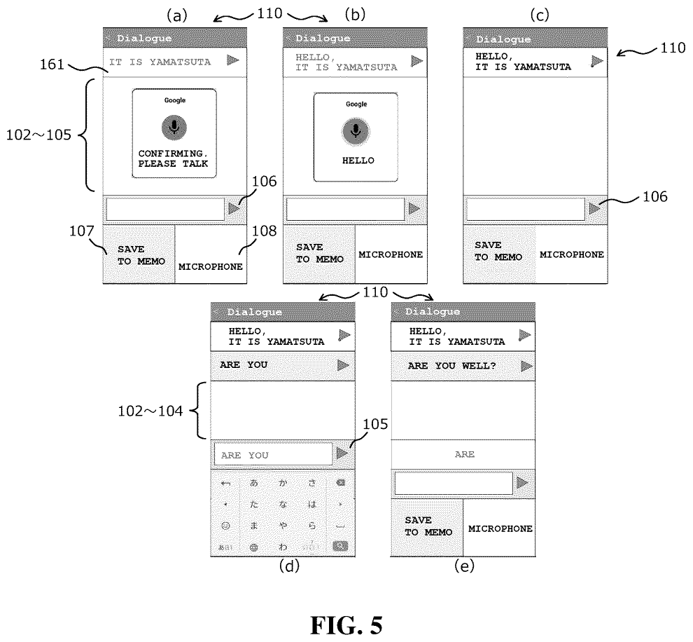

Moreover, the cursor (bold frame) matched with the block 1 at the time of transition to the display screen 10 then sequentially moves to blocks 2 to 6 that are tapped such as shown in FIGS. 4B to 4F, and a transition to a corresponding display screen is performed by double-tapping at the blocks 2 to 6 matched with the cursor. For example, when “dialogue” of the block 1 of FIG. 4A is double-tapped, the hierarchy level descends (an aspect of transition: also called “hierarchy level transition”), and a transition to a dialogue mode of FIGS. 5A-5E is performed (described below).

Note that, blocks L and R of the bottommost row are set as blocks having a so-called functional function, and “FORWARD” and “RETURN” are respectively set such as in the examples of FIGS. 4A-4D. A transition is performed from the display screen 10 to the display screen 10′ by double-tapping these blocks L and R. For example, scrolling (an aspect of transition different to a transition of the hierarchy level descends described above: also called a “scroll transition”) is performed from “MAIN PAGE 1” of FIG. 4A to “MAIN PAGE 2” of FIG. 4B, the cursor at the time of transition is matched with “SCHEDULE: WEB MEETING March 28, 13:00” of block 7, and “SCHEDULE: WEB MEETING March 28, 13:00” on “MAIN PAGE 2” is read out such as stated above.

Next, an input from an external device will be described while exemplifying the finger-mounted finger braille device 300 shown in FIGS. 2A and 2B. An external device (described below in detail) such as a finger-mounted device is connected to the mobile information terminal (smartphone) by wireless communication or the like such as Bluetooth (R) or Wi-Fi. The external device is recognized as a keyboard from the OS in the smartphone, and accepts battery state information of the external device, an English or Japanese keyboard input, a shortcut key (combination key, short continuous period) input, a microphone input or the like. The input by the external device is performed inside the display screen 10 or 10′ by an input of the blocks 1 to 6 of the smartphone assigned to input signals, a cursor movement, or an input of the blocks L and R of functional functions.

Specifically, in a cursor transition by the external device, by an input of “FORWARD” by the external device, at the time when moving through the blocks 1 to 6 inside the display screen 10 of the smartphone, moving through the blocks 7 to 12 inside the display screen 10′ to which scroll transition has been performed without change, and reaching a final block 12, “FINAL ITEM” is read out by a voice reading function of the smartphone. Inversely, by an input of “RETURN”, at the time when moving through the blocks 12 to 7 inside the display screen 10′ of the smartphone, moving through the blocks 6 to 1 inside the display screen 10 to which scroll transition has been performed, and reaching the first block 1, “FIRST ITEM” is read out. Moreover, at the time when an input of the blocks 1 to 6 and L and R of the smartphone is performed, an input by the block matched with the cursor is executed, and the display screen is hierarchy level transitioned (refer to the transition from the “DIALOGUE” block described above). Note that, a specific input example of the external device and output from the smartphone to the external device will be described below.

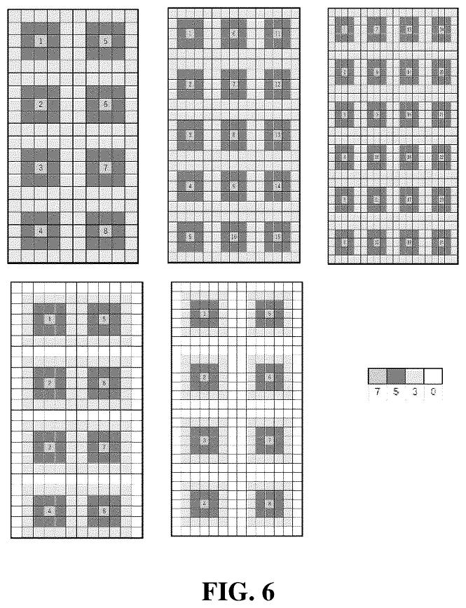

Next, the appropriateness of the division number of a display screen and the effectiveness of a response of each input/output section (block) will be described based on experimental results. FIGS. 6A-6E show simulated divided display screens 10A to 10E and reaction areas of each block for 5 types of smartphones that were actually used in experiments. For the division number, FIGS. 6A, 6D, and 6E show a simulated divided display screen of 8 blocks of 2 columns and 4 rows (2×4=8) similar to FIGS. 3A-3H and 4A-4D, FIG. 6B shows a simulated divided display screen of 15 blocks of 3 columns and 5 rows (3×5=15), and FIG. 6C shows a simulated divided display screen of 24 blocks of 4 columns and 6 rows (4×6=24). Moreover, for the ratio of reaction areas of each block, reaction regions that allow input by touching are shown as grey displays, and non-reaction regions that do not allow input are shown in white. In FIGS. 6A, 6B, and 6C, 100% (all) of the regions inside each block are reaction regions, in FIG. 6D, 69% of the regions from the center inside each block are reaction regions, and in FIG. 6E, 51% of the regions from the center inside each block are reaction regions.

Moreover, in this experiment, corrugated cardboard was laid out on a display region of a region assumed to be the same as that of a display screen of a 6-inch smartphone, the simulated divided display screens 10A to 10E were pasted thereupon, and experiments were performed by imitating a visually and hearing impaired person by having two test subjects A and B blindfolded in a state where thumbtacks were attached to the thumbs of both hands by tape, and read-out characters (braille numbers) were tapped. Moreover, a caregiver accompanied the test subjects, and in order to prevent characters from being arbitrarily selected, the caregiver read out random numbers generated by a computer, and read out the next number when a tapping point of the test subject was finished. This was repeated 24 times, and a time taken and tapping point accuracy were measured. The measurements of tapping point accuracy had a score higher at the center of a targeted block of the display screen, with a center reaction region 10a from the center toward the surroundings set as 7 points, a high reaction region 10b set as 5 points, a low reaction region 10c set as 3 points, a non-reaction region 10d in the periphery thereof set as 0 points (refer to each of the regions 10A to 10D of the block 1 of FIGS. 6A to 6E), and a total score of tapping points was aggregated for each test subject. A hypothesis was established in which the center was targeted as this total score increased, and a blind touch accuracy statistically increased.

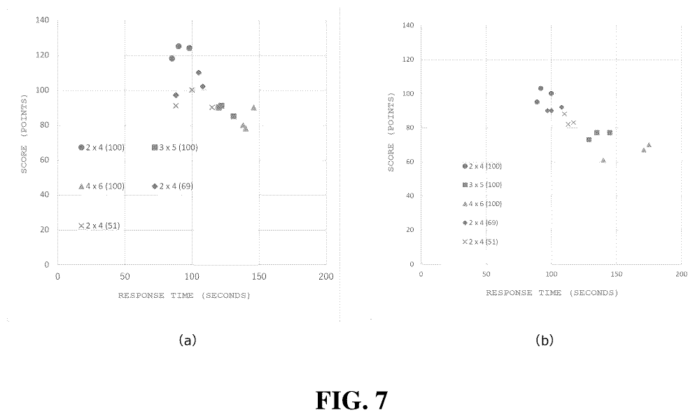

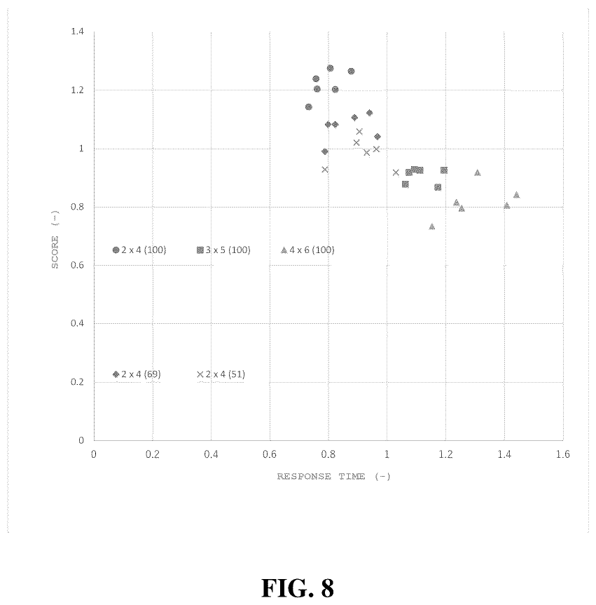

FIGS. 7A-7B and 8 each show a graph diagram showing a plot of a required time of each tapping point in each of the simulated divided display screens 10A to 10E (reaction time (seconds): horizontal axis) and a total score of tapping points at this time (score (points): vertical axis), FIG. 7A-7B show the results of test subject A (30 years old), and FIG. 8 shows the results of test subject B older than test subject A (60 years old). Moreover, FIG. 8 standardizes the experimental results of test subjects A and B in FIGS. 7A and 7B, and plots the experimental results on the same graph by eliminating individual differences. Specifically, an average value of the reaction time and score is obtained for each test subject, the reaction time and score of the test subject is standardized by each average value, and a calculation is performed such as described in detail below.

Reaction time (−: horizontal axis)=required time for each tapping point of each test subject/required time for all tapping points of the test subject

Score (−: vertical axis)=total score for each tapping point of each test subject/total score for all tapping points of the test subject

Note that, the circular marks 2×4 (100) within the plot are the results of the simulated divided display screen 10A of 2 columns and 4 rows (reaction region 100%) of FIG. 6A, the square marks 3×5 (100) are the results of the simulated divided display screen 10B of 3 columns and 5 rows (reaction region 100%) of FIG. 6B, the diamond marks 4×6 (69) are the results of the simulated divided display screen 10C of 2 columns and 4 rows (reaction region 69%) of FIG. 6D, and the cross marks 2×4 (51) are the results of the simulated divided display screen 10E of 2 columns and 4 rows (reaction region 51%) of FIG. 6E.

While roughly the same trends can be obtained by the two people of test subjects A and B from the results of the graph diagrams of FIGS. 7A and 7B, it is understood that a difference can be seen between the reaction time and tapping point correctness ratio by the test subjects. Specifically, in a comparison of the 3 conditions of the simulated divided display screens 10A to 10C (refer to FIGS. 6A to 6C) with a reaction region set to 100%, the reaction time of the simulated divided display screen 10A of 2 columns and 4 rows (2×4=8 blocks) is the shortest, and the score becomes the highest. Moreover, for the division number of the simulated divided display screen, the reaction times of a division number of 15 (3×5=15 blocks) and a division number of 24 (4×6=24 blocks) of FIGS. 6B and 6C are longer than the reaction time of a division number of 8 (2×4=8 blocks) shown in FIGS. 6A, 6D, and 6E, and the score decreases. In particular, it is understood that the reaction time increases as the division number increases, the score also decreases, and the variability also widens. In addition, in a comparison of the simulated divided display screens 10A, 10D, and 10E of FIGS. 6A, 6D, and 6E, it is understood that the reaction time extends as the reaction area ratio of the screen decreases, and the score also decreases.

By the above experimental results, it is understood that the reaction time of a visually and hearing impaired person becomes shorter and the tapping point accuracy becomes higher and more preferable as the division number of the display screen reduces and the reaction area ratio increases, and it is ideal for the reaction areas within FIGS. 6A-6E to form input/output sections (blocks) by being divided into 2 columns and 4 rows with a reaction area of 100%. In addition to this fact, when taking into consideration function keys of a familiar braille keyboard with general braille of 2 columns and 3 rows such as described above, it is understood that it is preferable to divide the display screen 10 of the smartphone into 2 columns and 4 rows, and it is ideal to form boundaries by partitions with orthogonality, without providing gaps between the blocks such as in FIG. 6A, in order to set the reaction area ratio of the divided blocks to a maximum (100%). From the above points of view, in the mobile information terminal (smartphone) of the present invention, a screen set with input/output sections (blocks) of 2 columns and 4 rows, in which the display screen is divided into 8 blocks by partitions with orthogonality, is formed as a main screen (main page).

### <<Example of a Lower Hierarchy Level Screen of 1 Column and 7 Rows>>

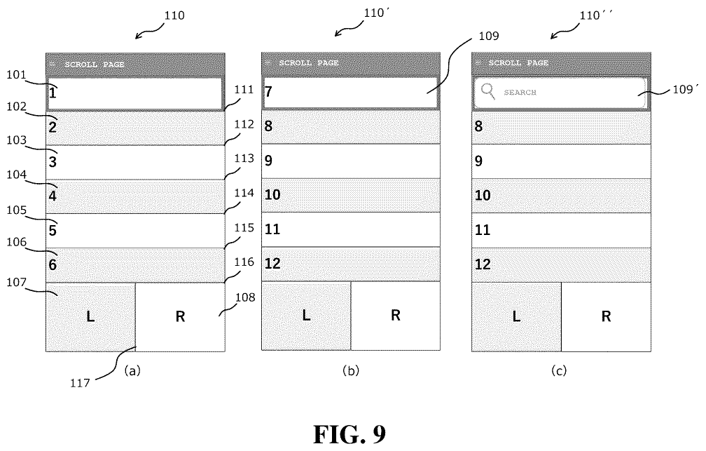

Next, FIGS. 9A-9C show an example that set the input/output sections (blocks) by dividing the display screen of the mobile information terminal (smartphone) into 8 blocks of 1 column and 7 rows (with the bottommost row having 2 columns). This example of blocks divided into 1 column and 7 rows sets 8 blocks 101 to 106 and blocks L and R (symbols 107 and 108) by dividing the entire display screen 110 of the smartphone such as shown in FIG. 9A. Moreover, the point that, when a cursor moves from block 6 (symbol 106) in the display screen 110 of 1 column and 7 rows, a scroll-transition is performed to a display screen 110′ of FIG. 9B for each screen of the display screen 110, the cursor is matched to block 7 (symbol 109) of the upmost level, zooming or scrolling inside the display screen 110 such as in a general smartphone display screen cannot be performed, and the display screen 110 is fixed as a single screen, is the same as the scroll-transition of FIGS. 3F to 3G of 2 columns and 4 rows described above.

Moreover, each of the blocks 101 to 108 of 1 column and 7 rows is formed by dividing the entire display screen 110 into 8 blocks by partitions 110 to 115 in a horizontal direction, a partition 115 in the bottommost row, and a partition 116 in a vertical direction having orthogonality, such as shown in FIG. 9A. Moreover, the blocks, other than performing hierarchy level transition to another page by double-tapping such as in blocks 1 to 6 of the display screen 110 of 2 columns and 4 rows described above, have a search box such as block 109″ on the uppermost row of display screen 110″ of FIG. 9C, and there may be cases of blocks that perform a hierarchy level transition after text is input to this search box (described below in detail).

Moreover, the point that, “FORWARD” and “RETURN” are set, for example, as blocks in which the blocks L and R (symbols 107 and 108) have a so-called functional function, the cursor is moved in the blocks 1 to 6 inside the display screen 110 by sequentially double-tapping “FORWARD”, the content of block 2 to 6 matched with the cursor is read out, a scroll-transition is performed to the display screen 110′ again with “FORWARD”, the cursor is matched with block 7 of the display screen 110′, and the title of the page and the content of the block 7 matched with the cursor are read out, is the same as the case of the display screen 10 of 2 columns and 4 rows described above in FIGS. 3A-3H.

On the other hand, the display screen 110 or the like of 1 column and 7 rows is not set as a main screen such as the display screen of 2 columns and 4 rows, but is a display screen having a complementary significance that performs a hierarchy level transition from 2 columns and 4 rows, and while it is in common for the point of being set by dividing the display screen into 8 input screens (blocks) by partitions having orthogonality, various modified examples may be set other than the search box such as in block 7 (symbol 109′ of FIG. 9C).

For example, a part of blocks 1 to 6 and 7 to 12 of the upper level 6 rows on 1 column and 7 rows can seemingly be set for a display screen of 1 column and 3 rows in which a plurality of blocks integrally displayed in parallel have the same function and transition destination, and function blocks L and R of the bottommost row of 2 columns, and on the contrary, one part of the blocks can be set to be blank, without including a transition destination. Moreover, other functional functions other than “FORWARD” and “RETURN” can be set for the function blocks L and R. One such modified example of 1 column and 7 rows (8 blocks) will be described below.

### Dialogue Mode

FIGS. 5A-5E show a display screen 110 to which a hierarchy level transition has been performed by double-tapping the “DIALOGUE” block of FIG. 4A, and the usage aspect thereof, as a “dialogue mode”. This display screen 110 is used at the time when a blind/deaf person or the like, who possesses an external device such as a finger-mounted finger braille device, performs a dialogue with a person in front of themself such as a caregiver. As shown in FIG. 9A, the display screen 110 uniformly displays blocks 102 to 105 of the second row to the fifth row, which have the same function, from among the 8 blocks 101 to 108 of 1 column and 6 rows, with the bottommost row having 2 columns, block 106 of the sixth row is set to a character input window, and a function for saving to a memo, and a function for activating a microphone, are respectively set for blocks L and R (symbols 107 and 108) of the bottommost row of 2 columns having a functional function.

Specifically, from among examples of conversations between a caregiver and a blind/deaf person, an example of an utterance from the caregiver to the blind/deaf person will be described while referring to the illustrations in FIGS. 5A-5E, and an utterance as a reply of the blind/deaf person to this will be described (not illustrated). First, in a state in which the display screen 110 is activated, (1) a microphone is activated by having a caregiver double-tap block 108, and when an utterance of “HELLO, IT IS YAMATSUTA”, for example, is performed, the fact that the microphone is activated at this time is displayed on a block that integrally displays blocks 102 to 105, and characters are sequentially output to block 101 by a voice recognition function of the smartphone (refer to FIGS. 5A to 5B). At this time, blocks 101 to 106 are activated only as an output function, and an input function is stopped. In the case where the caregiver determines that an utterance is correctly output to block 101, the caregiver transmits the utterance by single-tapping a transmission button 121 (triangular mark) inside the block 101 to which character output has been performed, and a display of a character string such as “HELLO, IT IS YAMATSUTA” on block 101 is fixed (refer to FIG. 5C). At this time, a finger braille signal is generated from characters at the same time as transmission, the generated finger braille signal is transmitted to an external device such as a finger-mounted finger braille device, and the blind/deaf person understands the content of the utterance of the caregiver by vibrations of the external device.

(2) Next, while not illustrated, the blind/deaf person receiving the utterance of the caregiver creates a reply. For example, in the case where the blind/deaf person inputs “IT HAS BEEN A LONG TIME” by the finger-mounted finger braille device, similar to FIGS. 5A to 5C described above in (1), a character string is sequentially displayed inside a block of a lower row to the block 101 displayed with “HELLO, IT IS YAMATSUTA” by receiving a character signal input by finger braille, a display of character strings is fixed when inputting the transmission button, and the content of the utterance is output by voice with a voice reading function. Note that, in FIGS. 5A-5E, since a further reply (described below) of the caregiver is displayed on block 102 in FIG. 5D, the block for the utterance of the blind/deaf person of (2) is not illustrated.

(3) Next, FIGS. 5D to 5E show a case where the caregiver performs a further utterance by receiving the utterance of “IT HAS BEEN A LONG TIME” as a reply of the blind/deaf person of (2). Here, while an exemplification is performed in the case where the caregiver performs an utterance of “ARE YOU WELL?”, an example is described in which the caregiver inputs characters directly on the display screen 110 of the smartphone placed in front of the blind/deaf person. In the state of FIG. 5C, a character direct input mode is activated when tapping the character input window of block 106. When the character direct input mode is activated, the positions of blocks 106 to 108 of the seventh row and eighth row are integrally displayed, a character input keyboard of the smartphone is displayed, the character input window displayed in block 106 on the sixth row in FIG. 5C is displayed on block 105 of the fifth row of one row above with the display of block 105 of the fifth row remaining unchanged, and a keyboard appears from underneath for visual confirmation by the caregiver. The caregiver sequentially taps the character input keyboard similar to that of a general smartphone, and characters are output at the same time within block 105 and block 102 (refer to FIG. 5D). At this time, blocks 103 to 104 become a blank state in which an input/output function is stopped, and the search box of block 105 has an output function of characters. In the case where the caregiver determines that their own input characters are output correctly to block 105, the caregiver performs transmission by single-tapping a transmission button 122 (triangular mark) inside block 105, and a display of a character string such as “ARE YOU WELL?” is fixed on block 102 (refer to FIG. 5E). The point that a finger braille signal is generated from characters at the same time as transmission, and the generated finger braille signal is transmitted to an external device such as a finger-mounted finger braille device, is the same as previously described.

In the “dialogue mode” such as described above in (1) to (3), there is a memo function for saving the dialogue content. In the case where the dialogue content is saved to a memo, the dialogue content is saved along with a series of dialogue information by reading time information data built into the smartphone by double-tapping or single-tapping the block 107 “SAVE TO MEMO” having a functional function. This saved data can be output from the block “Memo” at the time when transitioning to the main screen of 2 columns and 4 rows shown in FIG. 4A. In this memo function, not only is a series of conversations fixedly displayed on blocks 101 to 102 displayed, but a series of dialogues can also be understood with finger braille by a voice reading and finger-mounted finger braille device by reproducing the series of conversations immediately afterwards or at a later date.

### Finger-Mounted Finger Braille Device

Next, an explanation will be performed for an external device that can perform transmission and reception with respect to a smartphone having the above-described display screen 10 or 110 set with blocks divided into 8 by partitions with orthogonality. First, an improvement example of the finger-mounted finger braille device 300 developed by the inventors, which is shown in FIGS. 2B and 2C, will be described.

The finger-mounted finger braille device 300 shown in FIGS. 2B and 2C is provided on the fingers of a hand by a mounting tool, has a function as an external device for output that detects an operation of a finger and transmits this operation to the mobile information terminal (smartphone) 100 as character information such as braille, and has a function as an external device for input that creates operation information of finger braille corresponding to the character information received from the smartphone 100, and provides vibrations to the fingers of the hand based on this operation information.

Specifically, the finger-mounted finger braille device 300 includes:
an input/output unit, provided on a back side of each of the fingers, and including an operation detection unit that detects a finger braille operation of each of the fingers and a vibration unit that transmits finger braille to each of the fingers,
a main body unit that receives an operation signal corresponding to the finger braille operation of each of the fingers detected by the operation detection unit and specifies character information based on the operation signal, receives character information from the mobile information terminal and specifies a vibration operation to each of the fingers based on the character information, and transmits the specified vibration operation to the input/output unit, and
a transmission/reception unit that wirelessly transmits the character information specified by the main body unit to the mobile information terminal, receives the character information from the mobile information terminal, and transmits the received character information to the main body unit.

When the finger-mounted finger braille device 300 of such a configuration is set as an external device that can perform bidirectional communication with the smartphone 10, the finger-mounted finger braille device 300 functions as an input device of the smartphone 10, and a blind/deaf person can perform an input work by a finger operation similar to that of a familiar electronic braille keyboard, even if not directly tapping a block of the display screen 110 or the like of the smartphone 10. For example, in the case where executing the “dialogue mode” of FIGS. 5A-5E, in which the blind/deaf person and the caregiver are performing a conversation with the smartphone 10 placed in front of the blind/deaf person, the blind/deaf person performs an input work by using the finger-mounted finger braille device 300, and the caregiver performs an input by tapping the display screen 10 of the smartphone 10.

Moreover, when the finger-mounted finger braille device 300 functions as an output device from the smartphone 10, operation information by tapping the block of the display screen 110 of the smartphone 10 or the like, and character information such as input characters, title characters at the time of hierarchy level transition, or characters read out by a voice recognition function, can be conveyed by vibrations to the blind/deaf person by the finger-mounted finger braille device 300. In this way, direct tapping to the smartphone 10, and an input operation by an external device such as the finger-mounted finger braille device 300, can be confirmed by vibrations.

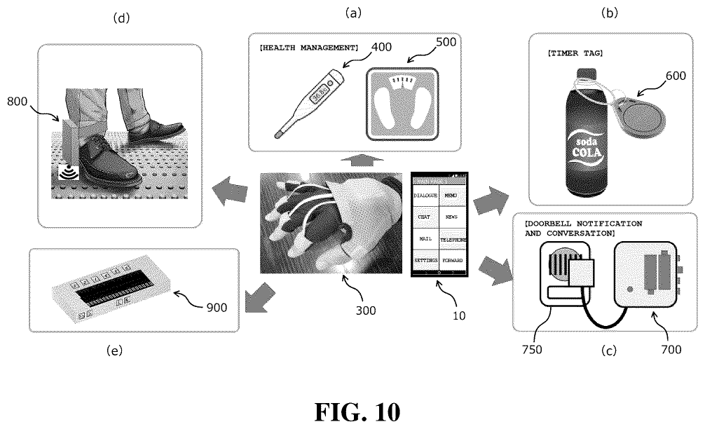

Next, FIGS. 10A-10E show an operation example of various types of external devices 300 to 900 using the mobile information terminal 10 and the above-described finger-mounted finger braille device 200. Hereinafter, the operations of each external device and the mobile information terminal 10 will be described.

### Health Management

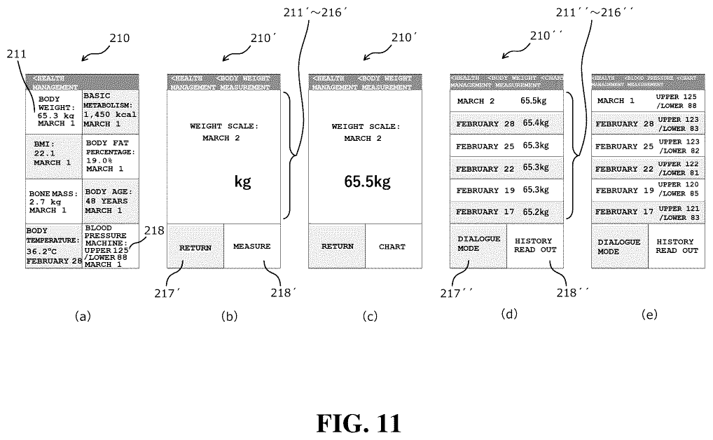

A health measurement device such as a thermometer 400 or a weight scale 500 is provided as an example, as an external device that performs daily health management of a visually and hearing impaired person by operating together with the smartphone 10, in FIG. 10A and FIGS. 11A-11E. In FIGS. 11A-11E, an example of a display screen 210 is shown for an application (health management application) that manages health information received from a health measurement device by the smartphone 10.

The thermometer 400 or the weight scale 500 (hereinafter, also called the “thermometer 400 or the like”) are each a general-purpose measurement device that can externally transmit a temperature, body weight or the like of a visually and hearing impaired person measured daily by a wireless communication means such as Bluetooth (R). When health data transmitted from the thermometer 400 or the like is received by the smartphone 10, this data is stored in a built-in storage unit or a cloud server or the like capable of bidirectional communication with the smartphone 10. The health management application is activated by performing a hierarchy level transition by double-tapping the block “HEALTH MANAGEMENT” of the main screen shown in FIG. 4C, and the display screen 210 divided into 8 blocks of 2 columns and 4 rows such as shown in FIG. 11A is displayed. At this time, data measured by the thermometer or the like 400 and stored is displayed on each set block, and is constantly updated into new data.

Moreover, for example, latest measurement data of the weight scale 500 is displayed, along with a measurement date, on block 211 “BODY WEIGHT: 65.3 KG March 1” of FIG. 11A, and a hierarchy level transition is performed to display screen 201′ shown in FIG. 11B. This display screen 201′ is a display screen orthogonally divided into 8 blocks of 1 column and 7 rows, with the bottommost row having 2 columns, shown in FIGS. 9A-9C described above, blocks 211′ to 216′ corresponding to blocks 1 to 6 of FIGS. 9A-9C are not capable of input, there is only a body weight and date display “WEIGHT SCALE: KG March 2” measured from this point onward, block 217′ corresponding to block L having a functional function on the bottommost row is set with the function “RETURN” that performs a hierarchy level transition to the display screen 201 of FIG. 11A, and block 218′ corresponding to block R is set with the function “MEASURE” that receives and records measurement data of the weight scale 500. When “MEASURE” of block 218 is tapped, body weight data transmitted form the weight scale 500 is received, and in the case where the measurement data of 65.5 kg, for example, this measurement data is displayed as “WEIGHT SCALE: 65.5 KG March 2” on blocks 211′ to 216′, such as shown in FIG. 11C, and is stored in the smartphone 10 or a cloud server that performs bidirectional communication thereof, and the body weight data of block 211 is newly updated to 65.5 kg at the time when performing a transition to the display screen 210 of FIG. 11A.

Moreover, when the body weight data is stored, a display of block 218′ of the display screen 201′ is changed to “CHART”, and hierarchy level transition is performed to a display screen 211″ that shows a list of most recent body weight data (refer to FIG. 11D). When the block 218′ of FIG. 11C is tapped, a date/time and data of an amount of the most recent 6 cases from among the body weight data stored on the smartphone 10 or a cloud server are read, the date/time and body weight data are displayed on each of blocks 211″ to 216″ of the display screen 211″ set by having blocks 211″ to 218″ orthogonally divided into 1 column and 7 rows, with the bottommost row having 2 columns, and can be output by voice with a voice reading function of the smartphone 10 by tapping block 208″ “HISTORY READ OUT” to perform a body weight history.

Other than this, in this health management application, various measurement data other than body weight or temperature can be managed, and measurement data wirelessly transmitted from a blood pressure machine, for example, can be recorded and displayed as a history, similar to FIGS. 11A to 11D. For example, most recent blood pressure data is displayed on block 218 of FIG. 11A and is measured and recorded by a display screen on which hierarchy level transition has been performed (similar to FIGS. 11B to 11C), and a most recent list is displayed such as shown in FIG. 11E.

As described above, a visually and hearing impaired person can perform daily health management for body weight, temperature or the like by the smartphone with this health management application.

### Recording Tag

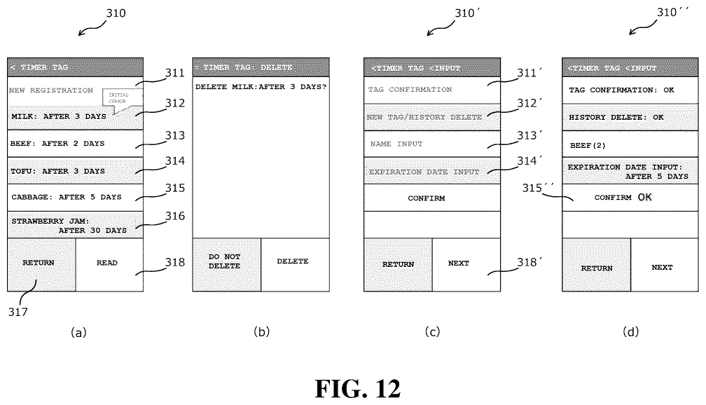

Next, as another utilization example of the smartphone 10, information management by a recording tag 600 shown in FIG. 10B and FIGS. 12A-12D is provided, as an external device that performs daily management of a visually and hearing impaired person by operating together with the smartphone 10. As one representative worry in everyday activity of a visually and hearing impaired person, there is a problem in which when purchased food and drink or home-made food and drink is stored in a refrigerator and thereafter consumed, the expiration date cannot be known. In FIGS. 12A-12D, information is obtained by NFC (near-field communication) built into the smartphone 10 from the recording tag 600, such as an IC/RF tag (RFID (Radio Frequency Identification) tag) that can be hung onto food or drink such as a plastic bottle within a refrigerator, and a product name and expiration date can be known. FIG. 10A shows an example of a display screen 310 for an application (expiration date management application) that manages a product name and expiration date of a product such as food or drink received from this recording tag 600 by the smartphone 10.

Here, in the case where the RFID tag is used in a built-in manner as the recording tag 600, the RFID tag and the smartphone 10 perform wireless communication with one another, and reading and rewriting of information recorded within the RFID tag can be performed. Roughly, in communication between the recording tag 600 and the smartphone 10, (i) radio wave information is irradiated from the RFID reader/writer built into the smartphone toward the recording tag 600, (ii) the irradiated radio wave information is received by an antenna of the recording tag 600, and a built-in IC chip is activated. Then, (iii) the radio wave information of the IC chip is transmitted from the antenna of the recording tag 600, (iv) the RFID reader/writer built into the smartphone 10 receives the radio wave information transmitted from the recording tag 600, (v) an expiration date application of the smartphone 10 processes the received content, and (vi) the processed content is stored in the smartphone 10 or a cloud server communicating thereto. Hereinafter, an explanation will be described by a specific display screen 310 on the smartphone 10.

When the block “RECORDING TAG” of FIG. 4C is double-tapped or the like, a hierarchy level transition is performed to the display screen 310 such as shown in FIG. 12A. This display screen 310 is a display screen orthogonally divided into 8 blocks of 1 column and 7 rows, with the bottommost row having 2 columns, the expiration date application displays a corresponding product and calculated expiration date for each of the blocks of (v), based on the date/time and tag information received in (iv) from each of various types of food and drink, on which the recording tag 600 is hung, in blocks 312 to 316, and the content of blocks 312′ to 316′ matched with a cursor is output to voice reading and the finger-mounted finger braille device 300. In this way, a visually and hearing impaired person can confirm an expiration date of food and drink on which the recording tag 600 is hung. Note that, the cursor is matched with block 312, at the time of performing a hierarchy level transition to the display screen 310.

Moreover, block 311 of the uppermost row is a block used at the time when newly performing registration by hanging a new recording tag 600 on food or drink, the cursor is matched by double-tapping the new recording tag 600, and when the block 318 “READ” is double-tapped within a range in which near-field communication can be performed with this recording tag 600, a hierarchy level transition is performed to a display screen 310′ divided into 1 column and 7 rows, with the bottommost row having 2 columns, which is shown in FIG. 12C, while reading the date/time and tag information recorded in the RFID of the recording tag 600, and confirmation of reading the recording tag 600 is displayed on block 311′ of the uppermost row of the display screen 310′ (at this time, a serial number or the like of the recording tag may also be listed). Then, the name of the read recording tag 600 is input to block 313′ and an expiration date is input to block 314′, and block 315′ “CONFIRM” is double-tapped to perform confirmation at block 315″ of the display screen 310′ for various types of confirmations of hierarchy level transitions. Note that, a detailed description has been left out, in the case where wanting to remove the recording tag 600, by referring to FIG. 12B that performs a hierarchy level transition from block 312′ to 316′ of FIG. 12A, block 312′ of FIG. 12C, and FIG. 12D.

In addition, the “expiration date management application” using this recording tag 600, other than for expiration date management of food and drink, can be utilized for content and cleaning management of clothes, or content and date/time management of photographs.

### Doorbell Unit

Next, as another utilization example of the smartphone 10, information management by a doorbell unit 700 shown in FIG. 10C and FIGS. 13 to 14 is provided, as an external device that performs daily management of a visually and hearing impaired person by operating together with the smartphone 10. As another representative worry in everyday activity of a visually and hearing impaired person, there is a problem of not realizing that a friend or delivery worker has rung a doorbell, and this was conventionally seen as simply an expensive item of having a simple function of only notifying a doorbell. In contrast to this, in a doorbell system provided by the smartphone, not only is a doorbell notified, but dialogue is also possible, by having a doorbell, the smartphone 10, and the finger-mounted finger braille device 300 operate together. Hereinafter, this will be briefly described.

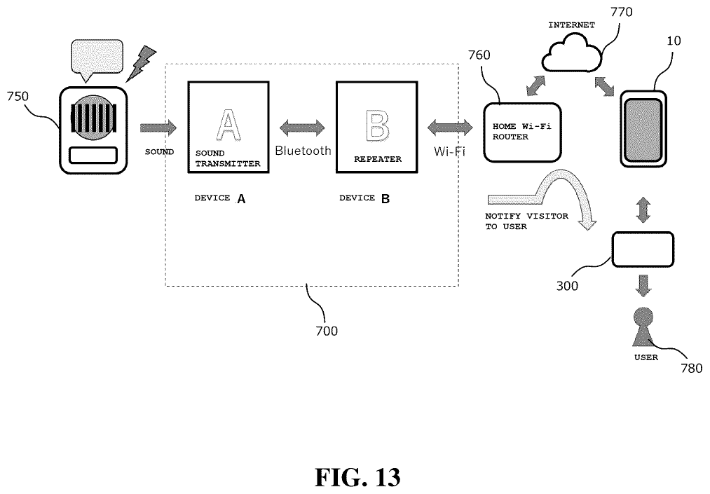

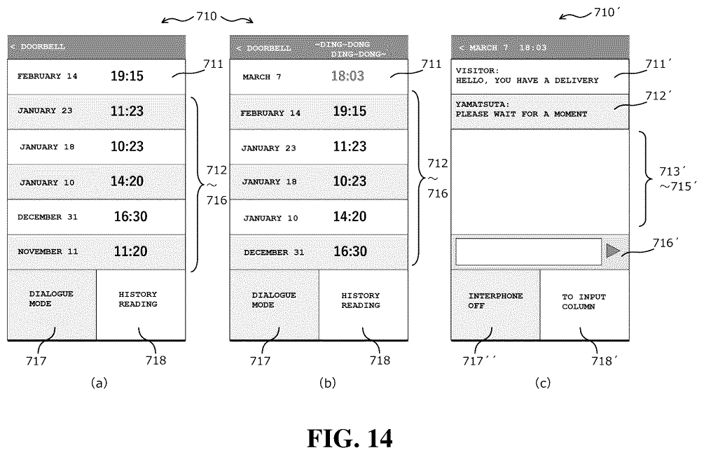

FIG. 13 shows a schematic diagram of a system configuration of a doorbell unit 700 and the finger-mounted finger braille device 300 as an external device operating together with the smartphone 10, and FIGS. 14A-14C show an example of a display screen 710 of the smartphone 10 at the time of using this system. As shown in FIG. 13, the doorbell unit 700 is mounted near a speaker of a general-purpose doorbell 750, and combines a device A and a device B. Device A is a sound transmitter/receiver that has a microphone sensor/speaker for receiving/transmitting sound from the doorbell 750 that notifies a visitor/sound from a user, and device B is a repeater that performs near-field communication such as Bluetooth (R) with the device A, and communicates a sound reception signal from the device A by Wi-Fi or the like. There are a case where the smartphone 10 or the finger-mounted finger braille device 300 directly receives a sound reception signal transmitted from the doorbell unit 700 (device B), and a case where the smartphone 10 receives the sound reception signal, via an interphone 770, from a house Wi-Fi router 760, and the finger-mounted finger braille device 300 that performs bidirectional communication with the smartphone 10 receives the sound reception signal.

FIG. 14A shows the display screen 710 of the doorbell unit 700 in which a hierarchy level transition has been performed by double-tapping block “DOORBELL” of the display screen of FIG. 4C. This display screen 710 is a display screen orthogonally divided into 8 blocks of 1 column and 7 rows, with the bottommost row having 2 columns, and a date/time history of sound reception signals having being received recently from the doorbell unit 700 is displayed in each of blocks 711 to 716. Block 717 is set as a block for executing an activation of a “dialogue mode”, which will be described below, and block 718 is set as block for executing reading out of the date/time history of blocks 711 to 716. Moreover, when the smartphone 10 receives a sound reception signal of the doorbell 50 being pressed, this sound reception signal is transmitted to the finger-mounted finger braille device 300, and a warning operation such as a vibration is executed. At this time, as shown in FIG. 14B, a date/time is displayed on block 711 on the uppermost row of the display screen 710, and a date/time of the most recent 5 cases up to this point are displayed on blocks 712 to 716 that are one row below.

In this way, in the case where a visually and hearing impaired person recognizes a sound reception from the doorbell 750, and desires a dialogue with a visitor, the visually and hearing impaired person activates the “dialogue mode” by double-tapping block 717. When the “dialogue mode” is activated, a hierarchy level transition is performed to display screen 710′(refer to FIG. 14C). When the “dialogue mode” is activated, it becomes a state in which a transmission signal form the smartphone 10 or the finger-mounted finger braille device 300 can be transmitted to the doorbell unit 700, and the speaker of the sound transmitter/receiver of the device A transmits a reply voice to the doorbell 750 via the device B of the doorbell unit 700 that receives this transmission signal.

For example, conversation content “HELLO, YOU HAVE A DELIVERY” of a visitor is characterized and displayed on block 711′, based on a sound reception signal from the interphone of the doorbell 750 to the block 711′ and a voice character conversion function of the smartphone, such as shown on the display screen 710′ of FIG. 14C. At this time, character information is transmitted to the finger-mounted finger braille device 300 from the smartphone 10, the finger-mounted finger braille device 300 creates vibrations for finger braille, and each finger of the visually and hearing impaired person vibrates. In response to this, the visually and hearing impaired person recognizing the conversation content of a visitor inputs reply content of “PLEASE WAIT FOR A MOMENT” to an input window provided in block 716′ (refer to FIGS. 5C to 5E), and the reply content is transmitted. This is repeated, and when the dialogue is completed, the “dialogue mode” is finished by double-tapping block 717′ “INTERPHONE OFF”.

### Pedestrian Navigation

Next, as another utilization example of the smartphone 10, a pedestrian navigation system by a visually impaired person foot-mounted tool 800 shown in FIG. 10D and FIGS. 15 to 17B is provided, as a regular external device that supports walking of a visually impaired person, by operating together with the smartphone 10 and the finger-mounted finger braille device 300. There are braille blocks on city sidewalks, and a visually impaired person walks by relying on the braille blocks by holding a white cane. However, it is unclear what destination or traffic light there is in front of the braille blocks, and many visually impaired people seek a means for desiring information guidance. Conventionally, various systems have been provided, which provide information and assistance for walking, by operating together with braille blocks. For example, while a system has been provided that adds a code for marking warning blocks from among braille blocks, and performs voice guidance by reading this code with a small-sized camera, and a system has been provided that provides a QR code (R) presenting guidance information on braille blocks, and reads the QR code (R) from a mobile smartphone, the reading accuracy of a visually impaired person that cannot recognize the locations of codes cannot be secured, and pedestrian safety also cannot be secured for a visually impaired person holding a white cane in one hand while possessing a device necessary for the system in the other hand. In addition, in the case of a blind/deaf person, there is also a problem that voice recognition cannot be performed. A practical application of a pedestrian assistance system that utilizes braille blocks cannot be performed from such circumstances.

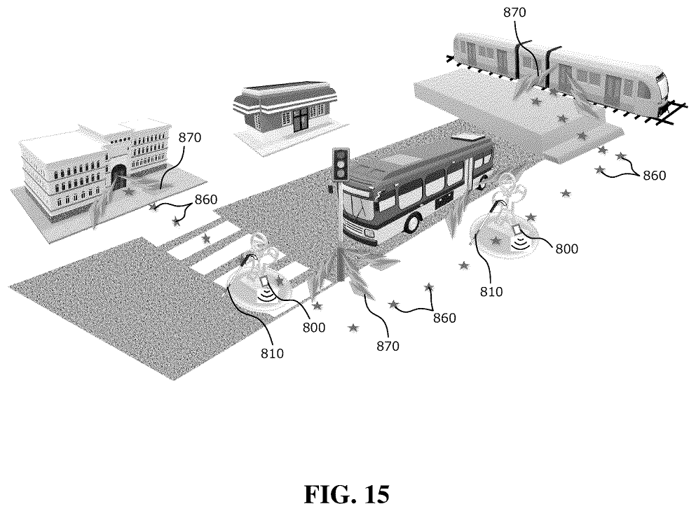

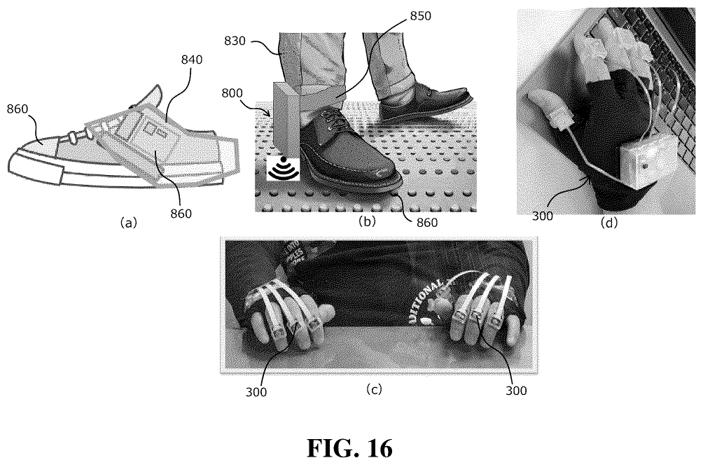

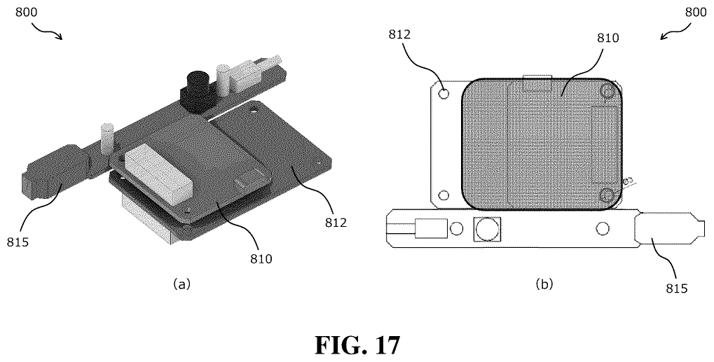

Such a problem should be resolved, and a pedestrian navigation system is provided, in which information of braille blocks that a visually impaired person during a walk recognizes as being in the vicinity (approximately 1 m to 2 m) of a white cane tip, and the smartphone 10 and the finger-mounted finger braille device 300 carried by the visually impaired person, are operated together by the visually impaired person foot-mounted tool 800 mounted as an external device on a foot of the visually impaired person when walking. Specifically, for example, the visually impaired person foot-mounted tool 800 is worn on a foot of the visually impaired person by placing a bag 840 accommodating the visually impaired person foot-mounted tool 800 therein over a shoe 860 (FIG. 16A), or wrapping the visually impaired person foot-mounted tool 800 around an ankle with a band 850 (FIG. 16B), and includes a substrate 810 or an antenna 815 with built-in near-field wireless communication module such as shown in the perspective view of FIG. 17A and the plan view of FIG. 17B, and the visually impaired person foot-mounted tool 800 irradiates radio waves to an IC tag 860 (also called a “passive tag”) embedded inside a braille block and in which guidance information is recorded, such as shown in FIG. 15. By receiving this irradiation, the IC tag 860 transmits a predetermined guidance information signal, and the visually impaired person foot-mounted tool 800 receives this signal. Moreover, the visually impaired person foot-mounted tool 800 receives a guidance information signal that is actively transmitted without limiting a targeted person from an IC tag 870 (also called an “active beacon”) embedded within a public transport facility such as a traffic light or train station premises and in which predetermined guidance information is recorded. For example, a guidance information signal is transmitted as a warning signal when irradiating radio waves from the visually impaired person foot-mounted tool 800 to the IC tag 860 at a position separated from a pedestrian route, and a guidance information signal is transmitted from the IC tag 870 embedded within a public transport facility as a live information signal such as the color of a traffic light or the arrival of a train.

When the visually impaired person foot-mounted tool 800 receives this guidance information signal, the guidance information signal is read by a reading device with a built-in RFID reader and wireless transmitter connected by wires to a signal transmitter within the visually impaired person foot-mounted tool 800, and is wirelessly transmitted to the smartphone 10 by near-field communication such as Bluetooth (R). When the visually impaired person foot-mounted tool 800 comes close to the IC tag 860 or 870, and a guidance information signal is transmitted from this IC tag 860 or 870, the guidance information signal is transmitted from this IC tag 860 or 870 to the smartphone 10 via the signal transmitter and reading device within the visually impaired person foot-mounted tool 800, a guidance information signal such as a warning is transmitted to the finger-mounted finger braille device 300 (refer to FIGS. 16C to 16D) worn by the visually impaired person via the smartphone 10, and a warning or the like is provided by vibrations to each of the fingers.

These vibrations are set with vibrations rules corresponding to predetermined guidance, and guidance information can be recognized. Active information, such as a route to a destination, the presence of a pedestrian crossing or a traffic light along the way, the color of a traffic light, or the arrival of a train, can be recognized by a visually impaired person, by installing a plurality of the IC tags 860 or 870 embedded in such braille blocks in a pedestrian path such as shown in FIG. 15, and pedestrian assistance can be performed in a beneficial and inexpensive manner. Note that, while an example has been shown in the above description in which a guidance information signal from the visually impaired person foot-mounted tool 800 is transmitted by the finger-mounted finger braille device 300 via the smartphone 10, there may be cases in which a guidance information signal is directly received by the finger-mounted finger braille device 300, and a vibration process is performed.

### Portable Braille Display and Finger Braille Input Device

Other than this, as a utilization example of the smartphone 10, a portable braille display and finger braille input device (hereinafter, also simply called a “portable electronic braille device”) 900, such as shown in FIG. 10E, which operates together with the smartphone 10, is provided. This mobile electronic braille device 900 is proposed as a small-sized portable device by extracting a braille output function (reading function) and a necessary finger braille input function of a conventional electronic braille device (refer to FIG. 2A). While a conventional electronic braille device is an input/output device for a visually impaired person, which is provided with an input keyboard, and a display unit that displays braille by having pins representing dots raised from holes pierced in a flat surface on a lower part, it has a high cost and is large in size.

In contrast to this, the finger-mounted finger braille device 300 can be mounted on the fingers, is very superior for portability, and becomes a core part as an external device operating together with the smartphone 10. However, a problem unique to finger braille also exists for the finger-mounted finger braille device 300. In the case where character information is received from the smartphone 10, which operates together with the finger-mounted finger braille device 300, and finger braille is read by vibrations, it will be necessary to perform reading work at least at the speed for performing finger braille. In contrast to this, the speed at which a visually and hearing impaired person generally reads braille tends to be significantly faster than reading work by finger braille. While it can be considered that this is overlooked as a limit of information transfer by finger braille, if taking “Leave No Deaf/Blind Person Behind” as a first principle from smartphone society, the inventors consider that an active development proposal should be performed with respect to a reading speed unique to finger braille that has been overlooked until the present time. The present inventors consider that it is desirable to perform the acquisition of character information at a braille reading speed, even for a visually impaired person always wearing the finger-mounted finger braille device 300. For example, in the case where inputting an input/output section “News” or “Braille Library” of FIGS. 4A and 4D, the inside of a display screen of a hierarchy level transition destination is configured with long text, and there are many visually impaired people that want to perform prompt reading. In the case where such long text reading occurs, there is a limit for reading by a vibration operation using the finger-mounted finger braille device 300. Therefore, in the case where focusing on reading a long text, it is considered to be desirable to carry an output device specialized for reading separately at the same time, even for a visually impaired person wearing the finger-mounted finger braille device 300. Here, from such a point of view, a portable electronic braille device 900 is provided, as an external device, which can perform transmission and reception with the smartphone 10, and can operate together with the finger-mounted finger braille device 300 via the smartphone 10, by having a braille reading function of character information from the smartphone 10, and a necessary input function for a finger braille input by each of 3 fingers of both hands (total of 6 fingers), and the portable electronic braille device 900 can be carried alone or together with the finger-mounted finger braille device 300.

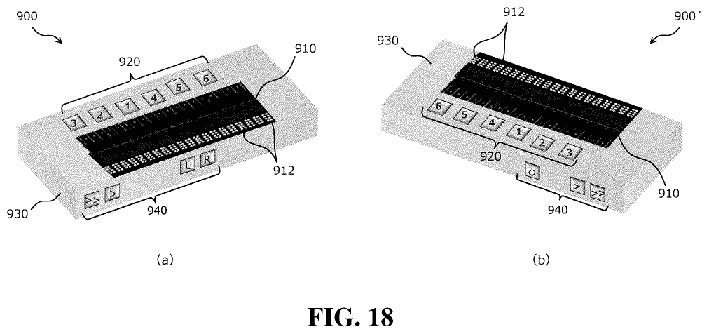

Specifically, FIG. 18A shows a perspective view of a portable electronic braille device 900, and FIG. 18B shows a perspective view of a portable electronic braille device 900′ in a modified example. The portable electronic braille devices 900 and 900′ each have a large and thick casing 930 to the same extent as that of a normal smartphone so as to enable operations while being carried. Firstly, the portable electronic braille devices 900 and 900′ each have a braille display unit 910, on the top surface of the casing 930, which performs conversion and transmission from general character information into braille information by an application within the smartphone 10, and displays a braille string corresponding to braille information wirelessly received by a transmission/reception device. This braille display unit 910 displays braille (dots) 912 in one string of approximately 20 characters by protruding/retracting pins driven by piezoelectric elements. The braille display unit 910 of the portable electronic braille device 900 of FIG. 18A is arranged on the lower part of the top surface of the casing 930, and the braille display unit 910 of the portable electronic braille device 900′ of FIG. 18B is arranged on the upper part of the casing 930. In this way, a visually impaired person can read character information from the smartphone 10 or the like in a few seconds as clauses formed by a braille string of 20 characters. Note that, there is a function input unit 940, on the upper edge part or the lower edge part of the casing 930, on which are arranged buttons for the braille 912 or a braille string of a braille display unit 910 to return 1 row, send 1 row, return 1 clause, or send 1 clause, or buttons corresponding to the function keys L and R (symbols 107 and 108) in the smartphone 10.

Moreover, finger braille input keys 920 are installed, on the top surface of the casing 930, with which a visually impaired person inputs characters by tapping with finger braille on an upper part (refer to FIG. 18A) or a lower part (refer to FIG. 18B) of the above-described braille display unit 910. These finger braille input keys 920 are 6 keys corresponding to the 3 fingers from the index finger to the ring finger of each hand necessary for finger braille, similar to the finger-mounted finger braille device 300. The number of 6 keys shown in FIGS. 18A and 18B corresponds to the number of 6 points of braille of FIGS. 1A-1B, similar to the finger-mounted finger braille device 300. Finger braille information received by the application inside the smartphone 10 is converted and output into general character information, by wirelessly transmitting the finger braille information input by these finger braille input keys 920 by a transmission/reception device, and the output finger braille information is output by the finger-mounted finger braille device 300 via the smartphone 10. Note that, the finger braille information input by the finger braille input keys 920 is output as a braille string by an operating unit that operates the above-described braille display unit 910 prior to transmission. Specifically, conversion and transmission are performed for braille information inside the smartphone 10 that receives finger braille information input by the finger braille input keys 820, and the received braille information is output by the braille display unit 910. In this way, a finger braille input can be confirmed as braille character strings beforehand even if unable to be confirmed by sight, and a check for incorrect characters or the like can be performed.

Heretofore, while examples of various mobile information terminals of the present invention have been shown, the present invention is not limited to these examples, and a person skilled in the art will understand there are other modifications and improvements within a scope that does not deviate from the thoughts and teachings of the patent claims.

### REFERENCE SIGNS LIST

10 mobile information terminal (smartphone)
11-14 partition
101-108 input/output section (block)
110 display screen
111-114 partition
210 display screen
211-218 input/output section (block)
300 finger-mounted finger braille device
400 thermometer
500 weight scale
600 recording tag
700 doorbell unit
710 display screen
711-718 input/output section (block)
800 visually and hearing impaired person foot-mounted tool
810 substrate
815 antenna
860, 870 IC tag
900, 900′ braille display and finger braille input device (portable electronic braille device)
910 braille display unit
912 braille
920 finger braille input key
930 casing
940 function input unit

1. A mobile information terminal, wherein
input/output sections are formed by dividing an entire display screen into 8 sections by partitions with orthogonality, and
each of the input/output sections is positioned within the entire display screen relative it.

2. The mobile information terminal according to claim 1, wherein
the input/output sections are formed by dividing the entire display screen into 8 sections by partitions with orthogonality, each input/output section consists of a total number of 8 sections, which include finger braille numbers assigned to three fingers of each hand of a visually and hearing impaired person, along with the two operation functions assigned to the other one finger of each hand, and
each of the input/output sections is positioned within the entire display screen relative it.

3. The mobile information terminal according to claim 2, wherein
each of the input/output sections is formed by dividing the entire display screen into 8 sections having a substantially same area and shape of 2 columns and 4 rows by the partitions with orthogonality, and
the display screen is configured of 3 rows of a left column assumingly assigned to 3 fingers of the left hand of the visually and hearing impaired person, 3 rows of a right column assumingly assigned to 3 fingers of the right hand of the visually and hearing impaired person, and 2 columns of a bottommost row assigned to both the left and right thumbs of the visually and hearing impaired person.

4. The mobile information terminal according to claim 2, wherein
the input/output sections are formed by dividing the display screen into sections with a substantially same shape of 1 column and 6 rows from the top and dividing the bottommost row into 2 columns, by the partitions with orthogonality.

5. The mobile information terminal according to claim 1, wherein
when a prescribed input/output section inside the display screen is selected and input, the prescribed input/output section transitions to another display screen having a preset fixed input/output section divided into 8 sections by partitions with orthogonality.

6. The mobile information terminal according to claim 5, wherein
the input/output section is displayed as one section having a same transition destination as adjacent one or more input/output sections and integrated with the one or more input/output sections, or
the input/output section does not have a transition destination and is in a display state incapable of input and output.

7. The mobile information terminal according to claim 1, wherein
the mobile information terminal comprises:
a transmission/reception unit that performs information transmission and reception wirelessly with an external device,
an input unit that inputs operation information to the input/output sections of the display screen of the mobile information terminal and input information to the external device based on the operation information, and transmits the input information to the external device to the transmission/reception unit, and
a display unit that outputs the operation information to the input/output sections of the display screen of the mobile information terminal and the output information from the external device received by the transmission/reception unit, and displays the operation information and the output information on a display screen of the mobile information terminal.

8. The mobile information terminal according to claim 7, wherein
the external device is a finger-mounted finger braille device attached to each finger of the left and right hands and capable of bidirectional wireless communication that can transmit to the mobile information terminal finger braille information from each finger or receive the finger braille information from the mobile information terminal, and
the finger-mounted finger braille device comprises:
an input/output unit, provided on a back side of each of the fingers, and including an operation detection unit that detects a finger braille operation of each of the fingers and a vibration unit that transmits finger braille to each of the fingers,
a main body unit that receives an operation signal corresponding to the finger braille operation of each of the fingers detected by the operation detection unit and specifies character information based on the operation signal, receives character information from the mobile information terminal and specifies a vibration operation to each of the fingers based on the character information, and transmits the specified vibration operation to the input/output unit, and
a transmission/reception unit that wirelessly transmits the character information specified by the main body unit to the mobile information terminal, receives the character information from the mobile information terminal, and transmits the received character information to the main body unit.

9. The mobile information terminal according to claim 8, wherein
character information recognized by a voice recognition function built into the mobile information terminal is displayed on the input/output sections divided by the partitions with orthogonality inside the display screen, and the character information is wirelessly transmitted to the finger-mounted finger braille device, and
the character information input to the input/output sections divided by the partitions with orthogonality inside the display screen is recognized by a voice reading function built into the mobile information terminal, and the recognized character information is output by a voice.

10. The mobile information terminal according to claim 7, wherein
the external device is a health management measurement device capable of wirelessly transmitting measurement information, the measurement information is received from the measurement device, the received measurement information is displayed along with a measurement date/time on the input/output sections divided by the partitions with orthogonality inside one display screen of the mobile information terminal, the displayed measurement information is stored in the mobile information terminal or stored in a server capable of communicating with the mobile information terminal, and each measurement information stored in each input/output section of another display screen transitioned from the one display screen displayed with the measurement date/time is displayed along with a date/time, and a history list display is formed.

11. The mobile information terminal according to claim 7, wherein
the external device is a recording tag with a built-in RFID capable of being attached to an arbitrary product, the recording tag recording product information in a rewritable manner,
when the product information is input at a prescribed input/output section of the mobile information terminal, an RFID reader/writer built into the mobile information terminal is started, causes the product information to be recorded and updated in the recording tag by transmitting the product information, the RFID reader/writer receives the product information recorded and updated by the recording tag, and the received product information is recorded and updated by the mobile information terminal or by a server that performs bidirectional communication with the mobile information terminal, and
when reading instruction information of the recording tag is input at another prescribed input/output section of the mobile information terminal, the RFID reader/writer is activated, the RFID reader/writer receives the product information recorded to the recording tag by transmitting the reading instruction information, and the received product information is displayed on the prescribed input/output section of the mobile information terminal.

12. The mobile information terminal according to claim 8, wherein
the external device is a doorbell unit and finger-mounted finger braille device that transmits and receives a doorbell and a voice,
doorbell voice information is wirelessly received from the doorbell unit, the received doorbell voice information is displayed as character information along with a received date/time on a prescribed input/output section inside the display screen of the mobile information terminal, and the character information is transmitted to the finger-mounted finger braille device, and
the character information is wirelessly received from the finger-mounted finger braille device, the received character information is displayed as character information on the prescribed input/output section of the mobile information terminal, and the character information is wirelessly transmitted as doorbell voice information output by the doorbell unit.

13. The mobile information terminal according to claim 8, wherein
the external device is a visually impaired person foot-mounted tool and the finger-mounted finger braille device that receives guidance information from an IC tag installed in a pedestrian path,
the visually impaired person foot-mounted tool wirelessly transmits a guidance information signal by reading the guidance information of the IC tag in the pedestrian path by a built-in RFID reader, and
the guidance information signal is wirelessly transmitted to the finger-mounted finger braille device via the mobile information terminal wirelessly receiving the guidance information signal from the visually impaired person foot-mounted tool.

14. The mobile information terminal according to claim 7, wherein
the external device is a mobile braille display and finger braille input device that wirelessly receives character information from the mobile information terminal and transmits a braille display or finger braille information to the mobile information terminal, and
the braille display and finger braille input device comprises a transmission/reception unit that wirelessly receives the character information from the mobile information terminal and wirelessly transmits the character information input by the braille display and finger braille input device, a braille display unit arranged with a plurality of braille formed by causing a pin to protrude and retract, a vibration unit that specifies a vibration of the pin for each braille based on the character information received by the transmission/reception unit from the mobile information terminal or the character information input by the braille display and finger braille input device, and causes the pin to protrude and retract, a finger braille input key having 6 keys corresponding to 3 fingers of each hand, and a finger braille input unit that transmits the character information input by the finger braille input key to the transmission/reception unit or the vibration unit.
